(19) United States
(12) Patent Application Publication
(10) Pub. No.: US 2012/0136484 A1
(43) Pub. Date: May 31, 2012

(54) DATA CENTER

(75) Inventors: Hao-Hao WANG, SHANGHAI (CN); Kang-Zhen LOU, SHANGHAI (CN); Xiao-Hua WANG, SHANGHAI (CN); Jian-Pei ZHANG, SHANGHAI (CN); Shen-Hsien LIU, TAIPEI CITY (TW)

(73) Assignee: INVENTEC CORPORATION, TAIPEI CITY (TW)

(21) Appl. No.: 13/011,934

(22) Filed: Jan. 24, 2011

(30) Foreign Application Priority Data
Nov. 30, 2010 (TW) 099141494

(51) Int. Cl. G06F 15/16; G05B 15/00

(52) U.S. Cl. 700/275; 709/224

(57) ABSTRACT

A data center is provided. The data center includes a plurality of racks, a container management network and a container management module. Each of the racks includes a rack management module and a plurality of server modules. The rack management module is used for receiving an operation status of the corresponding server module. The container management network is connected to the rack management module and the server module. The container management module is connected to each rack through container management network to receive the operation status for controlling and managing each rack according to the operation status.

### RELATED APPLICATIONS

This application claims priority to Taiwan Application Serial Number 099141494, filed Nov. 30, 2010, which is herein incorporated by reference.

### BACKGROUND

1. Field of Invention

The disclosure relates to a server architecture. More particularly, the disclosure relates to a data center.

2. Description of Related Art

Network is an indispensable tool in information communication and exchange in modern people's life. As an important tool for providing network services, a server must have the capability of processing a mass of data. Therefore, the server has to be well designed regardless of data processing or heat dissipation capability so as to achieve the most effective control and management.

In the design of an ordinary server system, normally, all respective servers therein generally function individually. The respective servers control their individual fans to dissipate heat after using their individual sensors for detection. However, when being applied on server systems including more and more servers, this design method does not take the overall system space into consideration, and thus cannot effectively improve the heat dissipation efficiency. Moreover, as to the overall system management, this design lacks of an overall control and management strategy.

Therefore, it is a problem desired to be solved by this industry regarding how to provide a data center with a central control and management scheme for achieving the effective management and heat dissipation.

### SUMMARY

Accordingly, an aspect of the disclosure is to provide a data center. The data center includes a plurality of racks, a container management network and a container management module. Each of the racks includes a rack management module and a plurality of server modules. The rack management module receives an operation status of the corresponding server module. The container management network is connected to the rack management module and the server module. The container management module is connected to each of the racks through the container management network to receive the operation status for controlling and managing each of the racks according to the operation status.

According to an embodiment of the disclosure, a number of the container management module is at least two which are redundant to each other. The container management module is a container management host.

According to another embodiment of the disclosure, the container management module provides a user network management platform.

According to still another embodiment of the disclosure, each server module is connected to an external Ethernet network through a working management network which is independent of the rack management network.

According to yet another embodiment of the disclosure, a number of the rack management module of each rack is at least two which are redundant to each other. The rack management module of each rack is a BMC (Baseboard Management Controller) chip. Each of the server modules of each rack includes a BMC used for monitoring and managing an operation status of the corresponding server module, so that the rack management network receives the operation status of each server module through the rack management network. Each BMC receives a power-on control signal to actuate the corresponding one of the servers. The power-on control signal is outputted by the rack management module to the BMC of one of the servers, so that the BMC randomly actuates the servers.

According to a further embodiment of the disclosure, each rack further includes a plurality of fan modules, and each fan module includes at least one fan, and the container management module controls a speed of the fan modules of each server module through the rack management module of each server module according to the operation status. The racks are arranged in a direction to form at least one rack row, and the fan modules of the racks of each rack row generates a heat dissipation airflow along the direction. The container management module directly controls and manages the server modules and the fan modules of rack through the container management network, or transfers a control right to the rack management module of the racks, so as to control and manage the server modules and the fan modules of the racks respectively through the container management network.

The container management module controls and manages the server modules through the rack management module of each of the racks according to the operation status. The operation status includes a temperature parameter, a voltage parameter, a power consumption parameter or any combination thereof. The container management network is an IPMI (Intelligent Platform Management Interface).

According to still another embodiment of the disclosure, the container management module controls and manages each of the server modules according to an input command, and controls the speed of the fan modules.

The application of the disclosure has the advantages of controlling and managing the server modules and adjusting the speed of the fan module, through the setting of the container management module; and based on the operation status of the server modules captured by the BMC of the server module via the container management network, thereby achieving the effect of central control and management, thus achieving the aforementioned objectives.

### BRIEF DESCRIPTION OF THE DRAWINGS

The invention can be more fully understood by reading the following detailed description of the embodiment, with reference made to the accompanying drawings as follows:

FIG. 1 is a block view showing a data center according to an embodiment of the disclosure;

FIG. 2 is a block view showing a rack in FIG. 1 according to an embodiment of the disclosure; and

FIG. 3 is a schematic view of a row of racks according to an embodiment.

### DETAILED DESCRIPTION

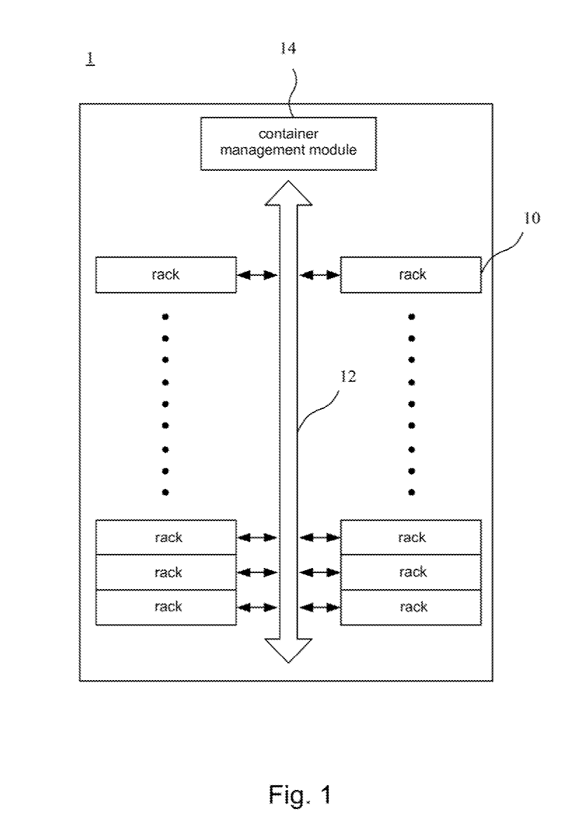

FIG. 1 is a block view showing a data center 1 according to an embodiment of the disclosure. Referring to FIG. 1, the data center 1 includes racks 10, a container management network 12 and a container management module 14.

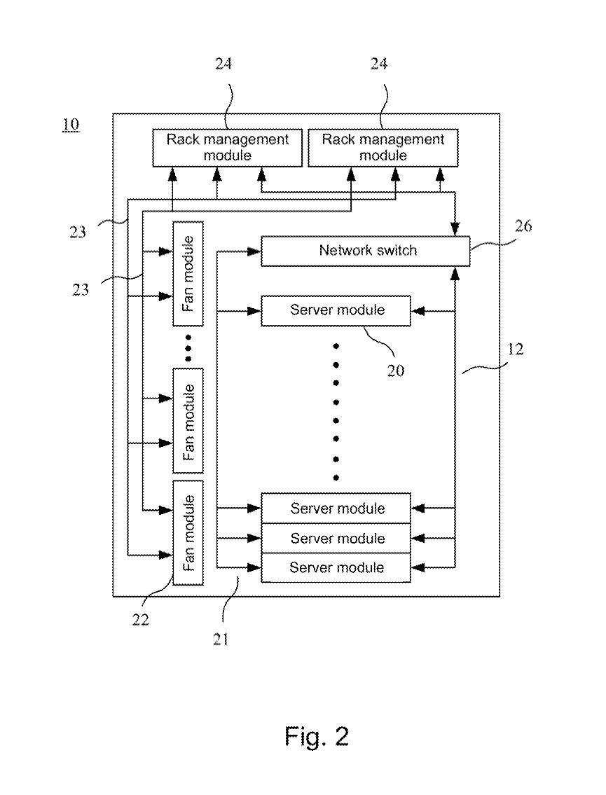

The number of the racks 10 is determined in accordance with actual applications. FIG. 2 is a block view showing a rack 10 according to an embodiment of the disclosure. Referring to FIG. 2 at the same time, the rack 10 includes server modules 20, fan modules 22, a container management network 12, at least one rack management module 24 and a network switch 26.

The number of the server modules 20 of the rack 10 is determined in accordance with actual applications. The server modules 20 may be connected to the container management network 12 and the working management network 21, which are independent from each other, according to different data types and processing manners, and process packets on different networks respectively through the network switch 26. The server module 20 may be connected to an external Ethernet network through the working management network 21 for perform data transferring and processing with a network device besides the server module 20.

The server module 20 substantially further includes a BMC (not shown). The rack management module 24 may communicate with the BMC of each server module 20 through the container management network 12. In an embodiment, the rack management module 24 is a BMC chip. Moreover, in an embodiment, a number of the at least one rack management module 24 may be greater than two which are redundant to each other. That is, at one identical time, the rack 10 has only one rack management module 24 in operation, and when the rack management module 24 in operation is damaged or down and cannot operate, the redundant rack management module 24 will perform communication with the server modules 20 instead.

In an embodiment, the container management network 12 is an intelligent platform management interface. Therefore, the rack management module 24 may communicate with the BMC of each server module 20 through the commands meeting the specification of the interface.

The BMC may access the sensor of the corresponding server module 20, so as to acquire the operation status such as a temperature parameter, a voltage parameter, a power consumption parameter or any combination thereof, thereby controlling the instant operation information and system status of the server module 20. The rack management module 24 may capture the operation status of the server module 20 from the BMC of each server module 20 through the container management network 12.

The container management network 12 in FIG. 2 is a part of the container management network 12 in FIG. 1. Therefore, the container management module 14 in FIG. 1 may be further connected to the rack management module 24 of each rack 10 shown in FIG. 2. In an embodiment, the container management module 14 is a container management host to process a mass of data and control and manage each rack 10. Two or more container management modules 14 which are redundant to each other may also be disposed.

After receiving the operation status of each server module 20, the rack management module 24 may return it to the container management module 14 through the container management network 12, so that the container management module 14 can monitor and manage the operation status of the server module 20. In another embodiment, the container management module 14 may be directly connected to the BMC of the server module 20 of each rack 10, and directly acquire the operation status from the BMC. After acquiring the operation status of the server module 20 of each rack 10, the container management module 14 may further control and manage each rack 10 according to the operation status.

For instance, the container management module 14 may control and manage the fan modules 22 of each rack 10 according to the operation status. In an embodiment, the container management module 14 may control the rack management module 24, so that the rack management module 24 communicates with the fan module 22 through the communication port 23 and controls its speed. The rack management module 24 may capture the instant operation speed of the fan module 22 and return it to the container management module 14, so that after acquiring the operation status of an internal temperature of each rack 10, the container management module 14 can make an instant adjustment according to the speed of the fan module 22. In an embodiment, the container management module 14 may store a fan speed meter to adjust the speed after reading the fan speed meter according to the information such as the temperature status and the operation speed of the fan.

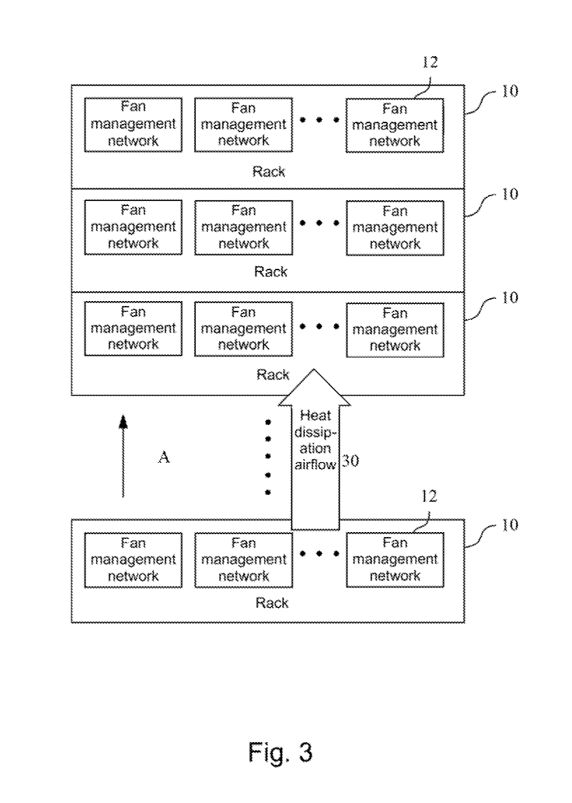

FIG. 3 is a schematic view of a row of racks 10 according to an embodiment. Referring to FIG. 3, in an embodiment, the racks 10 may be arranged in direction A as shown in FIG. 3 to form one rack row. The data center 1 in FIG. 1 may have several rack rows arranged in parallel as shown in FIG. 3. The fan modules 22 of the racks 10 in each rack row generates the heat dissipation airflow 30 to dissipate heat along the direction A, so that the data center 1 has a regular heat dissipation circulation direction, thereby avoiding the disordered internal airflow direction to cause the defect of poor heat dissipation efficiency, thereby achieving a better heat dissipation effect.

Therefore, the container management module 14 may acquire the operation status, for example, the overall temperature distribution of the overall data center 1 according to the operation status of the server modules 20 of all the racks 10, so as to control the speed of each fan module 22 in consideration of the status of the overall system, thereby achieving the objectives of the central control and management.

On the other hand, the container management module 14 may control a power up process of the server module 20 in each rack 10, so as to avoid an instant voltage or inrush current caused by the server modules 20 actuated altogether when the overall data center 1 is just actuated or the data center 1 is powered on again after power interruption. The container management module 14 may control the rack management module 24 through the container management network 12, such that the rack management module 24 outputs the power-on control signal to the BMC of one server module 20. After receiving the power-on control signal, the BMC actuates the corresponding server module 20. In an embodiment, the power-on control signal may be randomly transferred to any BMC, so that each server module 20 is randomly actuated, thereby eliminating the defect of the instant voltage or inrush current caused by the above simultaneous actuation.

Therefore, the container management module 14 may decide the power-on sequence of the server modules 20 of each rack 10 in a manner of central control and management, so that the phenomenon of inrush current or voltage caused by the simultaneous actuation of the power of the overall data center 1 will not occur.

In an embodiment, in regard with the control and management manner for the server module 20 in each rack 10, the container management module 14 may directly control the server modules 20 and fan modules 12 in each rack 10 without using the rack management module 24. In another embodiment, the container management module 14 may also transfer the control right to the rack management module 24, so as to respectively control the server modules 20 and fan modules 12 in each rack 10.

In still another embodiment, the container management module 14 may provide one user network management platform. That is, the host-type container management module 14 may provide one network management interface for the user to read the operation status of the server modules 20 in each rack 10. Moreover, the container management module 14 may also receive the input command through the user network management platform, so as to control and manage each server module 20 and control the speed of the fan module 22. In an embodiment, the container management module 14 may sequentially output the power-on control signal respectively to the server modules 20 according to the input command generated by the user network management platform, so that the server modules 20 are sequentially actuated.

The application of the disclosure has the advantages of controlling and managing the server modules and adjusting the speed of the fan module, through the setting of the container management module; and based on the operation status of the server modules captured by the BMC of the server module via the container management network, thereby achieving the effect of the central control and management.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A data center, comprising:
a plurality of racks each of which comprises at least one rack management module and a plurality of server modules, wherein the rack management module is used for receiving an operation status of the server modules;
a container management network connected to the rack management modules and the server modules; and
a container management module connected to each of the racks through the container management network to receive the operation status for controlling and managing each of the racks according to the operation status.

2. The data center of claim 1, wherein a number of the container management module is at least two which are redundant to each other.

3. The data center of claim 1, wherein the container management module provides a user network management platform.

4. The data center of claim 1, wherein each of the server modules is connected to an external Ethernet network through a working management network which is independent of the rack management network.

5. The data center of claim 1, wherein the container management module is a container management host.

6. The data center of claim 1, wherein a number of the at least one rack management modules of each of the racks is at least two which are redundant to each other.

7. The data center of claim 6, wherein each of the server modules of each of the racks comprises a baseboard management controller (BMC) used for monitoring and managing an operation status of the corresponding server module, so that the rack management network receives the operation status of each of the server modules through the rack management network.

8. The data center of claim 7, wherein the baseboard management controller receives a power-on control signal to actuate the corresponding one of the servers.

9. The data center of claim 8, wherein the power-on control signal is outputted by the rack management module to the baseboard management controller of one of the servers, so that the baseboard management controller randomly actuates the servers.

10. The data center of claim 1, wherein each of the racks further comprises a plurality of fan modules, each of the fan modules comprising at least one fan, the container management module controlling a speed of the fan modules of each of the server modules through the rack management module of each of the server modules according to the operation status.

11. The data center of claim 10, wherein the racks are arranged in a direction to form at least one rack row, and the fan modules of the racks in each of the at least one rack row generate a heat dissipation airflow along the direction.

12. The data center of claim 10, wherein the container management module directly controls and manages the server modules and the fan modules of the racks through the container management network.

13. The data center of claim 10, wherein the container management module transfers a control right to the rack management module of the racks, so as to control and manage the server modules and the fan modules of the racks respectively through the container management network.

14. The data center of claim 1, wherein the rack management module of each of the racks is a baseboard management controller chip.

15. The data center of claim 1, wherein the container management module controls and manages the server modules through the rack management module of each of the racks according to the operation status.

16. The data center of claim 1, wherein the operation status comprises a temperature parameter, a voltage parameter, a power consumption parameter or any combination thereof.

17. The data center of claim 1, wherein the container management network is an intelligent platform management interface (IPMI).

18. The data center of claim 1, wherein the container management module controls and manages each of the server modules according to an input command, and controls the speed of the fan modules.
